(19) United States
(12) Patent Application Publication
(10) Pub. No.: US 2024/0377839 A1
(43) Pub. Date: Nov. 14, 2024

(54) FLIGHT VEHICLE LANDING METHOD, FLIGHT VEHICLE, INFORMATION PROCESSING DEVICE, AND PROGRAM

(71) Applicant: AERONEXT INC., Tokyo (JP)

(72) Inventor: Yoichi SUZUKI, Tokyo (JP)

(21) Appl. No.: 18/554,408

(22) PCT Filed: Apr. 9, 2021
(86) PCT No.: PCT/JP2021/015076

§ 371 Date: Oct. 6, 2023

(51) Int. Cl. G05D 1/654; G05D 1/49; G05D 1/606; G05D 109/25

(52) U.S. Cl. CPC G05D 1/6545; G05D 1/49; G05D 1/606; G05D 2109/25

(57) ABSTRACT

A landing method, etc., for a flight vehicle having directional characteristics, which can improve the landing performance of the flight vehicle having directional characteristics by turning the airframe in a nose direction with a good balance between lift and drag based on wind speed data and wind direction data related to the landing site. In the method for landing a flight vehicle of the present invention, the flight vehicle comprises to generate lift in response to wind from the nose direction of the airframe and based on wind speed data and wind direction data related to the landing site, the nose direction of the airframe is controlled and the descent of the airframe is initiated.

### TECHNICAL FIELD

This invention relates to a method of landing a flight vehicle, a flight vehicle, an information processing apparatus, and a program.

### BACKGROUND ART

In recent years, research and demonstration tests have been conducted toward the practical application of services using flight vehicles such as drones and unmanned aerial vehicles (UAVs) (hereinafter collectively referred to as “flight vehicles”). For industrial applications in the fields of delivery, research, and surveillance, the use of autonomous flight vehicles that can fly, take off, and land without human control is being considered.

Such flight vehicles are desired to extend their range and improve their flight time in order to improve the quality of service and uptime. As shown in FIG. 18, flight vehicles used for filming, etc., have been required to have less directional characteristics so that they can easily change their direction of travel in various directions and have a faster response time. However, flight vehicles in industries such as home delivery do not move in various directions like flight vehicles used for filming, but instead move in a fixed direction (e.g., forward) as their main direction of movement. In these industries, there is a need to optimize movement in specific directions and improve flight efficiency. In light of this situation, Patent Literature 1 discloses a flight vehicle that reduces the load on the rotor blades. (See, for example, Patent Literature 1).

### PRIOR ART LIST

### Patent Literature

[Patent Literature 1] US2020-0001995A1

### SUMMARY OF THE INVENTION

### Technical Problem

In Patent Literature 1, the body part has a tip and a trailing edge that face each other, a top and a bottom that is laid between the tip and the trailing edge, and two side parts, thereby reducing the drag force when the flight vehicle moves forward. By setting the angle between the normal of the reference plane of the body part and the axis of rotation of the rotor blades between 5 and 30 degrees, a positive angle of attack is formed when the rotor blade aircraft moves forward, and the lift generated by the body part reduces the load on the rotor blades, and the airframe has been developed to improve flight time.

This method makes it possible to extend the flight distance of flight vehicles. On the other hand, the flight vehicle's lift-generating configuration may cause the landing operation to take longer or be more difficult. This is because when the flight vehicle in the hovering posture receives wind from the nose direction during the landing operation, lift is generated and the flight vehicle is lifted up.

Flight vehicles used in industries such as home delivery need to improve not only the efficiency of their flight, but also their operating rate. To improve the operating rate, it is effective to shorten the time required for takeoff and landing as well as to increase the flight speed. If the flight vehicle configuration for improved flight efficiency generates lift during the landing operation and increases the time required for the landing operation, it may be difficult to achieve compatibility with the improvement in operating rate.

Therefore, the purpose of this invention is to provide a landing method for flight vehicles that can improve the landing performance of directional flight vehicles.

### Technical Solution

According to the present invention, a landing method, etc., of a flight vehicle can be provided, wherein the flight vehicle is configured to generate lift in response to wind from the nose direction of the vehicle, and based on wind speed and wind direction data related to the landing site, the nose direction of the vehicle is controlled and the descent of the vehicle is initiated.

### Advantageous Effects

According to the present invention, a method of landing a flight vehicle, etc., which can improve the landing performance of a flight vehicle with directional characteristics can be provided.

### BRIEF DESCRIPTION OF THE DRAWINGS

FIG. 1 shows a schematic diagram of a flight vehicle used in a landing method, viewed from the side during a flight.

FIG. 2 shows a top view of the flight vehicle of FIG. 1.

FIG. 3 shows a side view of the flight vehicle of FIG. 1 during hovering.

FIG. 4 shows a top view of the flight vehicle shown in FIG. 4.

FIG. 5 shows a functional block diagram of the flight vehicle shown in FIG. 4.

FIG. 6 shows a side view of the flight vehicle shown in FIG. 1 when the nose of the flight vehicle is pointed upwind during landing.

FIG. 7 shows a side view of the flight vehicle of FIG. 1 when it turns its nose downwind during landing.

FIG. 8 shows a side view of the flight vehicle of FIG. 1 with its nose pointing upwind during landing.

FIG. 9 shows a side view of the flight vehicle of FIG. 1 with its nose pointing downwind during landing.

FIG. 10 shows a side view of other flight vehicles used in the landing method of the present invention during a flight.

FIG. 11 shows a diagram of the flight vehicle of FIG. 10 when hovering.

FIG. 12 shows a top view of the flight vehicle of FIG. 10.

FIG. 13 shows a side view of other flight vehicles used in the landing method during a flight.

FIG. 14 shows a diagram of the flight vehicle of FIG. 13 when hovering.

FIG. 15 shows a schematic diagram showing the wind direction in the flight environment of the flight vehicle.

FIG. 16 shows a top view of other flight vehicles used in the landing method of the present invention.

FIG. 17 shows a top view of other flight vehicles used in the landing method of the present invention.

FIG. 18 shows a top view of a less directional flight vehicle.

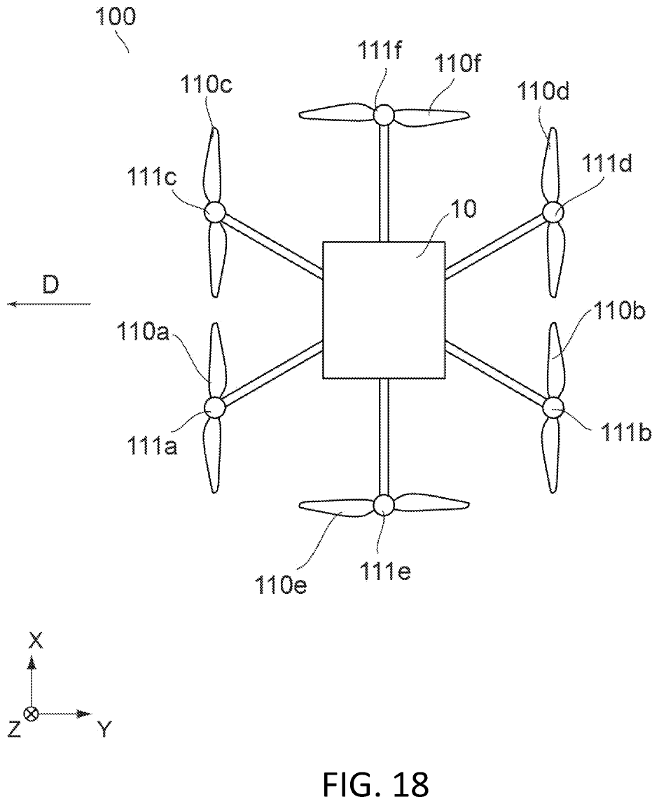

The contents of this embodiment of the invention are described in a list. The method of landing a flight vehicle, etc., according to this embodiment of the invention consists of the following.

### [Item 1]

A method of landing a flight vehicle,
wherein the flight vehicle generates lift in response to wind from the nose direction of its airframe, comprising:
controlling the nose direction of the airframe based on wind speed data and wind direction data related to the landing site, and initiating the descent of the airframe.

### [Item 2]

The method of landing a flight vehicle according to item 1,
wherein the lift force is generated by the shape of the body of the airframe.

### [Item 3]

The landing method for a flight vehicle according to item 1,
wherein the lift force is generated by the wing parts of the airframe.

### [Item 4]

The method of landing a flight vehicle as in any one of items 1 to 3,
wherein the controlling of the nose direction of the airframe is a yaw rotation on-the-spot.

### [Item 5]

The method of landing a flight vehicle as in any one of items 1 to 3,
wherein the control of the nose direction of the airframe is a turn.

### [Item 6]

The method of landing a flight vehicle as in any one of items 1 to 5,
wherein the controlling of the nose direction of the airframe is upwind of the nose direction of the airframe when the wind speed indicated by the wind speed data is in the first wind speed range where no lift is generated.

### [Item 7]

The method of landing a flight vehicle as in any one of items 1 to 6,
wherein the controlling of the nose direction of the airframe is to set the nose direction of the airframe to the downwind side when the wind speed indicated by the wind speed data is in the second wind speed range that generates the lift force.

### [Item 8]

The method of landing a flight vehicle according to item 7,
wherein the controlling of the nose direction of the airframe is to set the nose direction of the airframe to the windward side when the wind speed is in the third wind speed range, which is even stronger than the second wind speed range.

### [Item 9]

The method of landing a flight vehicle according to item 7,
wherein the control of the nose direction of the airframe is to change the planned landing site if the wind speed is in the third wind speed range, which is even stronger than the second wind speed range.

### [Item 10]

A flight vehicle,
wherein the flight vehicle generates lift in response to wind from the nose direction of the airframe,
wherein the nose direction of the airframe is controlled based on wind speed data and wind direction data related to the landing site to initiate the descent of the airframe.

### [Item 11]

An information processing apparatus for executing a landing method for a flight vehicle,
wherein the flight vehicle generates lift in response to wind from the nose direction of the airframe,
wherein the method of landing the flight vehicle is controlling the nose direction of the airframe based on wind speed data and wind direction data related to the landing site, and initiating the descent of the airframe.

### [Item 12]

A program for causing a computer to execute a method of landing a flight vehicle,
wherein the flight vehicle generates lift in response to wind from the nose direction of its airframe, comprising steps of:
controlling the nose direction of the airframe; and
initiating the descent of the airframe, based on wind speed data and wind direction data related to the landing site.

### DETAILED DESCRIPTION OF THE EMBODIMENTS ACCORDING TO THIS INVENTION

Methods of landing a flight vehicle according to this embodiment of the invention are described below with reference to the drawings.

### Details of the First Embodiment

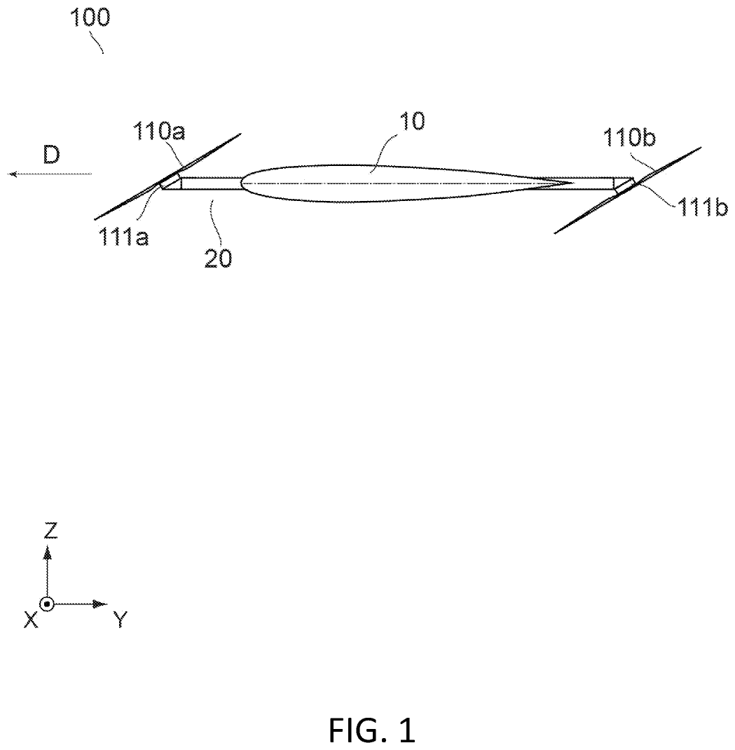

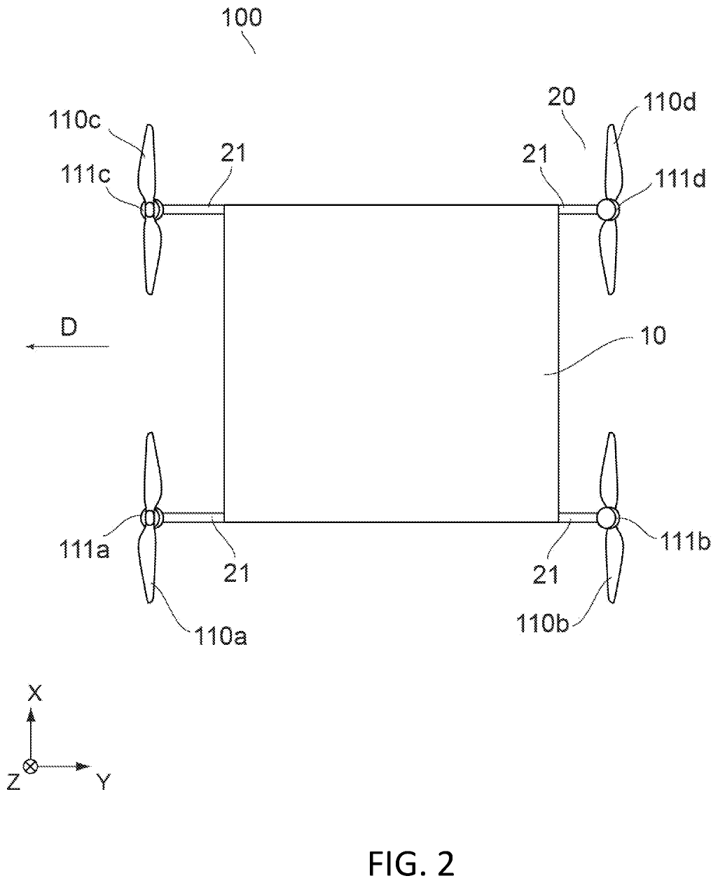

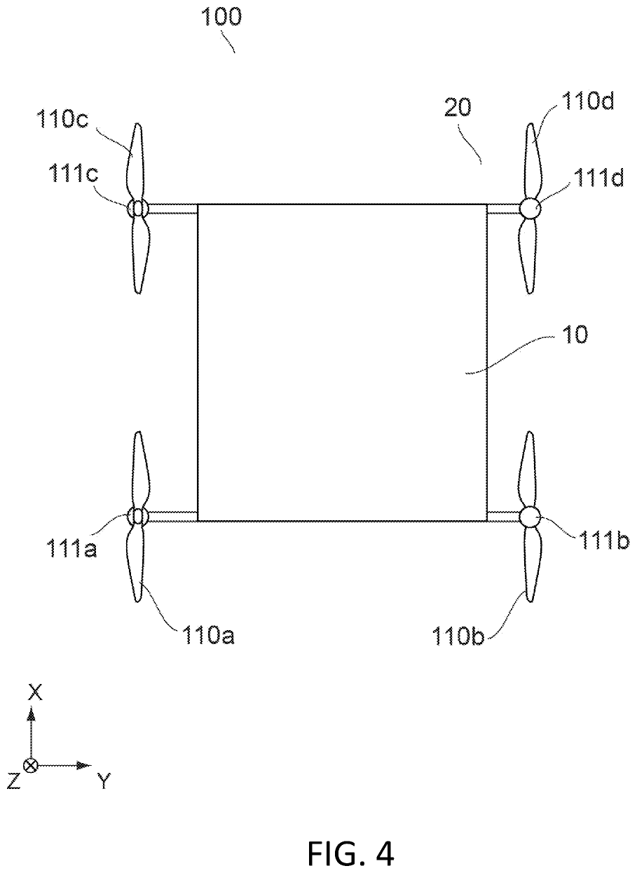

As illustrated in FIG. 1-FIG. 4, the autonomous flight vehicle according to this embodiment has a flight part 20 that comprises at least elements such as a propeller 110 and a motor 111 to perform flight, and equipped with energy (e.g., secondary batteries, fuel cells, fossil fuels, etc.) to operate them. Flight vehicles used for delivery, investigation, surveillance, etc. should preferably be flight vehicles equipped with multiple propellers and motors, called VTOLs or multicopters, which are capable of vertical takeoff and landing and do not require a large area such as a runway, from the perspective of reducing the area used during takeoff and landing.

The flight vehicle 100 shown in the figure is depicted in a simplified form to facilitate the explanation of the invention's structure, and detailed components such as the control part, for example, are not shown in the figure.

The flight vehicle 100 is moving forward in the direction of arrow D (-Y direction) in figures. (see below for details).

In the following explanation, the terms may be used according to the following definitions. Forward and backward: +Y and −Y, up and down (or vertical): +Z and −Z, left and right (or horizontal): +X and −X, forward direction (forward): −Y, rearward direction (backward) direction (backward): +Y direction, ascending direction (upward): +Z direction, descending direction (downward): −Z direction

The propeller 110 rotates under the output from the motor 111. The rotation of the propeller 110 generates propulsive force to take the flight vehicle 100 off from the starting point, moving object, and landing at the destination. The propeller 110 can rotate to the right, stop, and rotate to the left.

The propeller 110 provided by the flight vehicle of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the vane can be selected as appropriate to optimize the dynamic aerodynamic characteristics of the vane, such as increasing lift and thrust and reducing drag.

The propeller provided by the flight vehicle of the invention may be, but is not limited to, fixed pitch, variable pitch, or a mixture of fixed and variable pitch.

The motor 111 produces rotation of the propeller 110: for example, the drive unit can include an electric motor, engine, or the like. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flight vehicle 100 determines the number of revolutions of each motor and the angle of flight according to the wind speed and direction by means of a flight controller, a propo, or the like. As a result, the flight vehicle can move by ascending or descending, accelerating or decelerating, and changing direction.

The flight vehicle 100 can fly autonomously according to routes and rules set in advance or during the flight, or it can be piloted using a propo/radio.

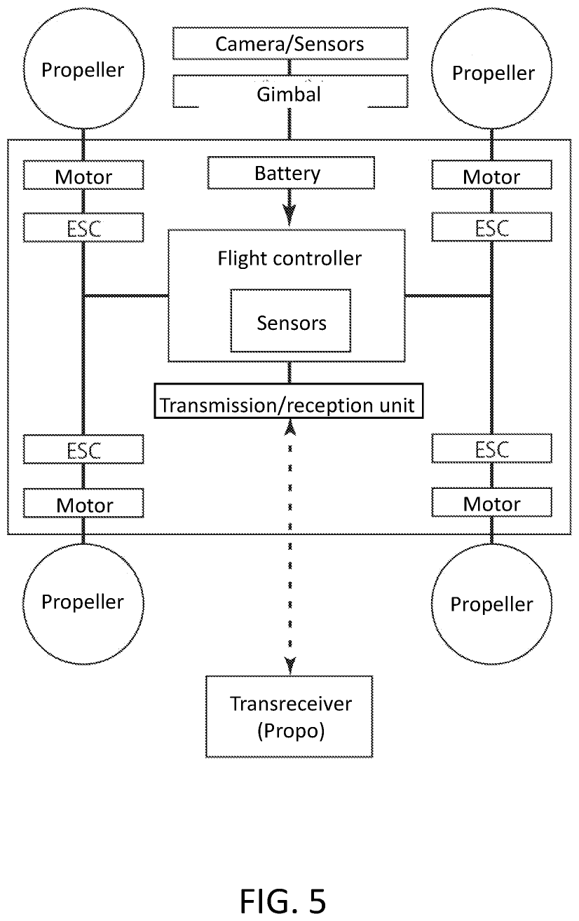

The flight vehicle 100 described above has the functional blocks illustrated in FIG. 5. The functional blocks in FIG. 5 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from cameras and sensors may be directly transmitted to and stored in the memory. For example, still and moving image data captured by a camera or other device is recorded in the internal or external memory.

The processing unit includes a control module comprising to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y and z, and rotational motion θx, θy and θz). The control module can control one or more of the states of the onboard parts and sensors.

The processing unit is capable of communicating with a transmission/reception unit comprised of one or more external devices (e.g., terminal, display, or other remote controller) to transmit and/or receive data. The transceiver can use any suitable means of communication, such as wired or wireless communication. For example, the transmission/reception unit can use one or more of the following: local area network (LAN), wide area network (WAN), infrared, wireless, WiFi, point-to-point (P2P) network, telecommunications network, or cloud communications. The transmission/reception unit can transmit and/or receive one or more of the following: data acquired by sensors, processing results generated by the processing unit, predetermined control data, and user commands from a terminal or remote controller.

Sensors in this embodiment can include inertial sensors (accelerometers, gyroscopes), GPS sensors, proximity sensors (e.g., lidar), or vision/image sensors (e.g., cameras).

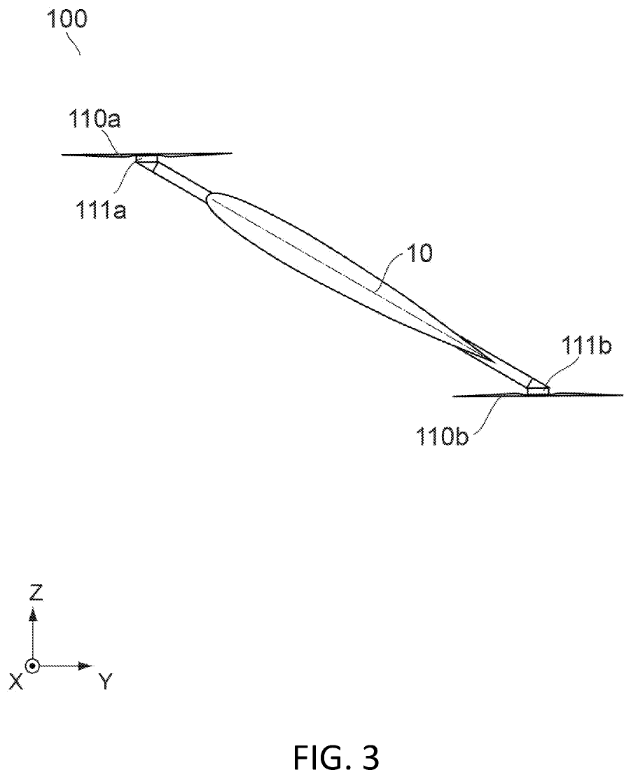

As illustrated in FIG. 1 and FIG. 3, the propeller 110 provided by the flight vehicle 100 in this embodiment faces the plane of rotation upward or downward when, for example, ascending, descending, or hovering in no wind. In other words, the axis of rotation of the propeller 110 extends substantially vertically. When traveling, the rotating surface tilts forward toward the direction of travel compared to when ascending, descending, or hovering. The propeller 110, with its rotational surface tilted forward, generates upward lift and thrust in the direction of travel by the rotation of the motor 111, which causes the flight vehicle 100 to move forward.

The flight vehicle 100 has a main body part 10 that can contain the on-board processing unit, battery, and the load 30. The main body part 10 is fixedly connected to the flight part 20. The main body part 10 changes its attitude as the flight part 20 changes its attitude. The shape of the main body part 10 is optimized to increase the speed and efficiently shorten the flight time in the attitude of the flight vehicle 100 during cruising, which is expected to be maintained for a long time during the flight vehicle 100.

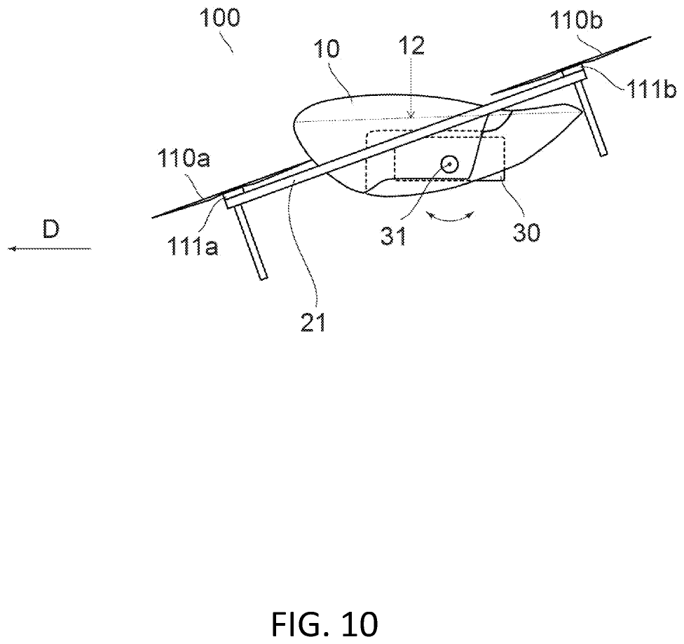

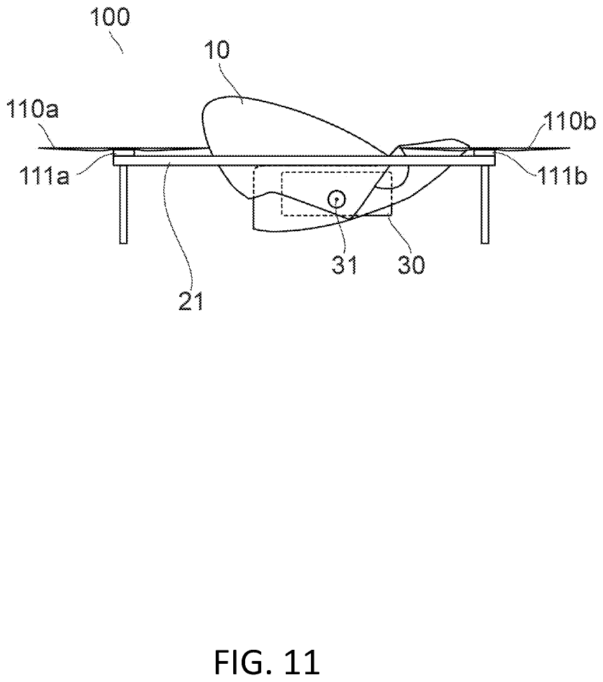

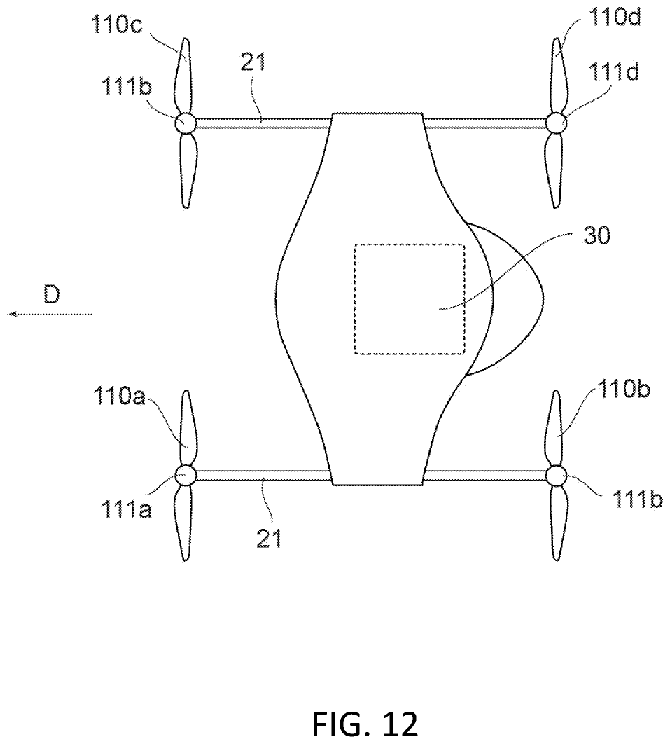

As illustrated in FIG. 10-FIG. 12, the load 30 on the flight vehicle 100 may be independently displaceable and connected to the flight part 20. By being independently displaceable, the attitude of the load 30 can be set to a predetermined angle (e.g., horizontal) regardless of the attitude of the flight part 20.

The main body part 10 should have an outer skin that is strong enough to withstand flight, takeoff and landing. For example, plastic, FRP, or the like are suitable materials for the outer skin because of their rigidity and water resistance. These materials may be the same material as the frame 21 (including arms) included in the flight part 20, or they may be different materials.

The motor mount, frame 21, and main body part 10 of the flight part 20 may be comprised of connected parts, or they may be molded as a single unit using a monocoque structure or one-piece molding (e.g., the motor mount and frame 21 are molded as a single unit, the motor mount, frame 21, and main body part 10 are molded as a single unit, etc.). By integrating the parts as one piece, the joints between each part can be made smooth, which is expected to reduce drag and improve fuel efficiency of flight vehicles such as blended wing bodies and lifting bodies.

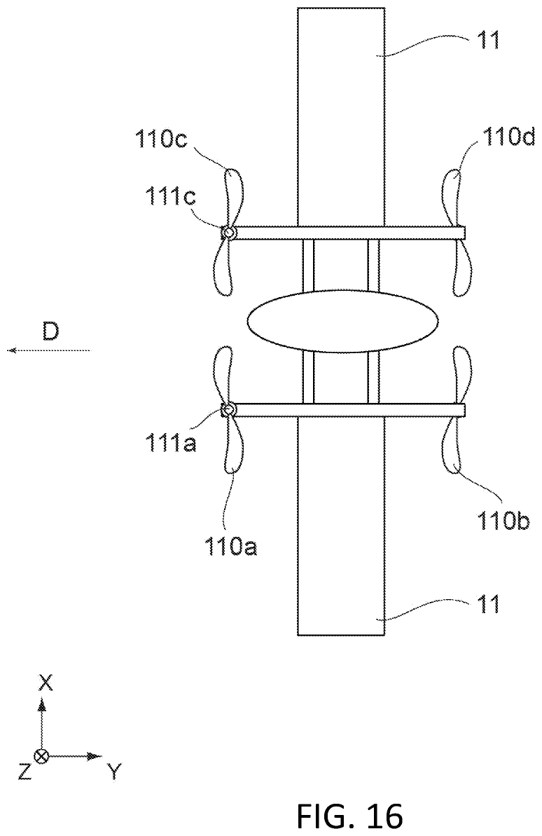

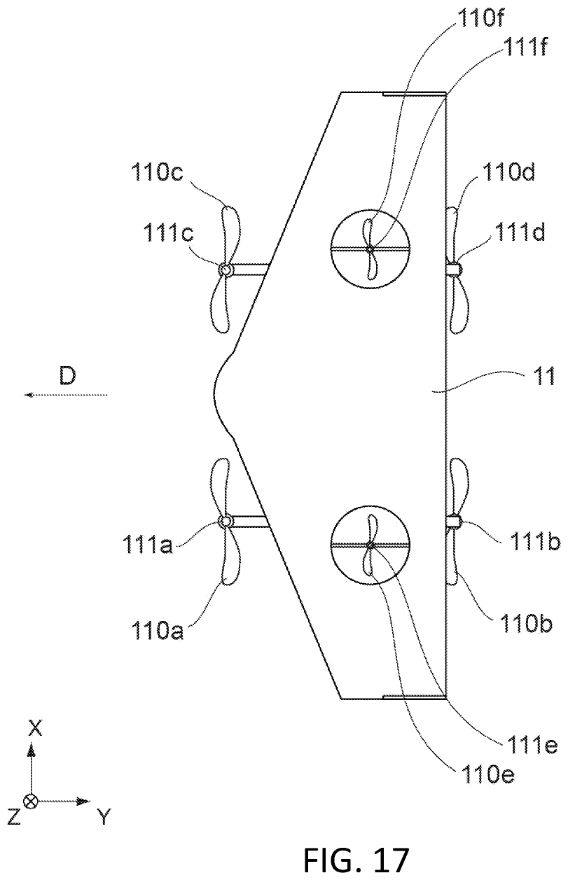

The flight vehicle 100 has at least one of the main body part 10 or the wing part 11 comprising a shape (e.g., streamlined or otherwise, having a tip and a trailing edge facing each other and also having a surface material laid between the tip and the trailing edge connecting them) that is low drag when the flight vehicle 100 is in cruising attitude. For example, the flight vehicle illustrated in FIG. 16 is configured with a wing part 11 separate from the main body part 10, while the flight vehicle illustrated in FIG. 17 is an all-wing aircraft in which the entire airframe is comprised of the wing part 11. In the flight vehicle shown in FIG. 16 and FIG. 17, at least the wing part 11 are provided so that the flight vehicle 100 has a low drag shape in cruising attitude. This reduces the effect of relative wind received from the nose direction when the flight vehicle is cruising, thereby improving the fuel consumption of the flight vehicle. As shown in Patent Literature 1, it is desirable to use a shape that generates positive lift for applications that use the lift generated by the main body part 10 or wing part 11, and conversely, a shape that does not generate lift or generates negative lift for applications that do not use the lift generated by the main body part 10 or wing part 11.

In order not to reduce the reliability of the flight vehicle, mechanisms such as tilt wings and tilt rotors should not be used, and if used, the tilt angle (range of motion) should be narrowed.

As illustrated in FIG. 1-FIG. 4, to reduce the drag force during flight vehicle cruise compared to hovering in a configuration without a tilt mechanism, the main body part 10 or wing part 11 is designed to have a smaller positive angle of attack during cruise and a larger positive angle of attack during hover. It is presumed that when the flight vehicle receives wind from the nose direction at the angle of attack from the hovering attitude to the cruising attitude, the flight vehicle will experience a positive lift force.

The flight vehicle 100 of the invention is an autonomous flight vehicle that can automatically perform at least part of its flight and takeoff/landing without being controlled by a person who can observe it visually. By using GNSS and data obtained from various sensors, the flight vehicle's position and data on the surrounding environment are acquired, and the flight vehicle's processing unit or outboard equipment determines its course, speed, avoidance of obstacles, and other actions.

The coordinate data used by the flight vehicle 100, such as destination, route, etc., may be given in advance before takeoff, or may be given during flight using communications. When only the destination is specified and no route to the destination is given, or when a route is given but is allowed to change, the flight vehicle itself may determine the route based on obstacles, weather, and other data acquired through communication or sensors.

In a flight vehicle 100 where the main body part 10 is directional, it is further preferred that the nose direction of the flight vehicle 100 faces upwind. It is possible to efficiently reduce the drag force against the wind (the combined force of the environmental wind and the wind generated by the forwarding motion) that is applied to the flight vehicle 100.

When the flight vehicle 100 reaches the vicinity of its destination over the sky, it enters the landing step. At this point, the flight vehicle descends with the main body part 10 facing a predetermined direction so that the descent is not hindered by the lift force generated by the main body part 10, thereby ensuring a smooth landing.

The flight vehicle 100 that performs the landing method according to the invention acquires or estimates at least one of the wind direction data or wind speed data that blows toward the flight vehicle by means of sensors onboard the flight vehicle 100, data acquired from external sources, or calculations from a database, before starting the landing operation. Depending on the value of the wind direction or wind speed data, the processing unit determines whether or not to change the nose direction of the flight vehicle and the direction of the change. The threshold values that serve as criteria for determining whether or not to change the nose direction and in which direction the change should be made are determined in advance according to the flight vehicle's configuration and characteristics (e.g., assumed landable wind speed and assumed cruise speed). For example, an airframe designed for landing performance and an airframe designed for cruise performance have significantly different allowable wind speeds that allow for a smooth landing with the nose of the airframe facing directly into the wind.

Changing the nose direction can be accomplished by turning the flight vehicle 100 or by rotating it in the yaw direction on the spot. For example, by setting the nose direction downwind, the flight vehicle 100 is less likely to generate lift and will lean back to counter the wind and take a negative angle of attack, making it easier to descend.

The start of the change of nose direction may be made after the flight vehicle reaches directly over the destination, or it may be made between the takeoff point and the arrival at the destination. Especially in an environment where wind speed and direction are predicted for a specific date and time based on topography and seasonal winds, it is possible to determine a predetermined direction in advance and set the route so that the flight vehicle approaches the destination with the nose pointed in that direction. At this time, further modifications may or may not be made based on actual observation data.

For flight vehicles with a high operational altitude (e.g., those with a cruising height of 50 meters or more above the surface), the control of nose direction may not be performed during the descent from the operational altitude to the predetermined altitude, but the control of nose direction may be initiated after the flight vehicle has descended to a predetermined altitude (e.g., near the ground surface, such as 10 meters from the ground surface). This is because the descent to the predetermined altitude is often a descent with forward movement and turning, among other things, to improve stability. In this case, nose direction control need not be performed because there is little need for nose direction control while the aircraft is not in a vertical descent. On the other hand, below a predetermined altitude (e.g., near the ground surface), the descent is performed substantially vertically to avoid contact with obstacles, etc. Therefore, nose direction control is necessary to ensure a stable descent. Thus, it is desirable that the nose direction control be performed when (e.g., before) the substantially vertical descent is initiated. If, as described above, the flight vehicle's descent is initiated with a horizontal moving object, such as moving forward or turning, it is desirable that the nose direction control be performed when the flight vehicle switches to a substantially vertical descent.

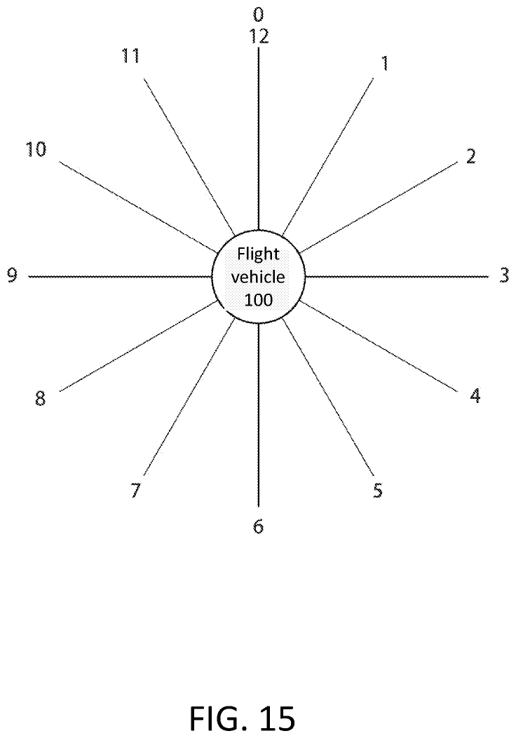

An example of the operation of flight vehicle 100 with threshold and actual wind speed data is explained based on the schematic illustrated in FIG. 15. In the following description, the wind is assumed to blow from direction 0 (12). When a number indicates a specific range, it shall be displayed clockwise: for example, “direction 1-direction 4” includes directions 1, 2, 3, and 4.

Suppose there is no or weak wind against the flight vehicle 100. In that case, the nose of the flight vehicle 100 does not change direction because the landing of the flight vehicle 100 will be under the same conditions regardless of which direction the nose of the flight vehicle 100 is facing from direction 0 to direction 12. Next, within the predetermined wind speed range, the flight vehicle's nose direction is changed to direction 6. Finally, suppose the wind speed exceeds the predetermined range. In that case, the control method is adjusted according to the excess speed and the characteristics of the 100 flight vehicle (e.g., changing the nose direction of the flight vehicle 100 to either direction 0-direction 12).

Suppose the wind is within the first wind speed range, such as no wind or light wind, and the value of the wind speed is within the range where the hovering main body part 10 or wing part 11 does not generate lift to raise the flight vehicle 100 due to the wind. In that case, the nose direction change operation shall not be performed. If the amount of lift produced by the main body part 10 or wing part 11 is such that it does not cause the flight vehicle 100 to rise, it does not significantly interfere with the landing of the flight vehicle 100. Therefore, the flight vehicle 100 shall reduce the power output of each rotor blade and quickly descend vertically without any change in nose direction.

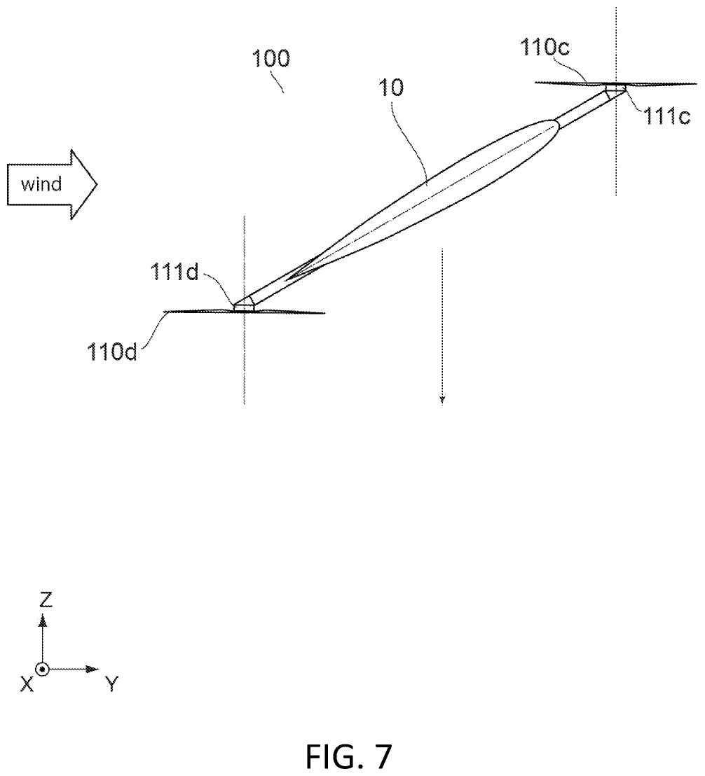

On the other hand, if the wind is within the second wind speed range above the first wind speed range, the nose direction is changed to the downwind side, as illustrated in FIG. 7. The flight vehicle 100 then descends with a backward control, in which the output of the rotor blades in the nose direction is greater than the output of the rotor blades in the tail direction. At this time, the retraction component and the wind may cancel each other out, resulting in an apparent descent that is substantially vertical.

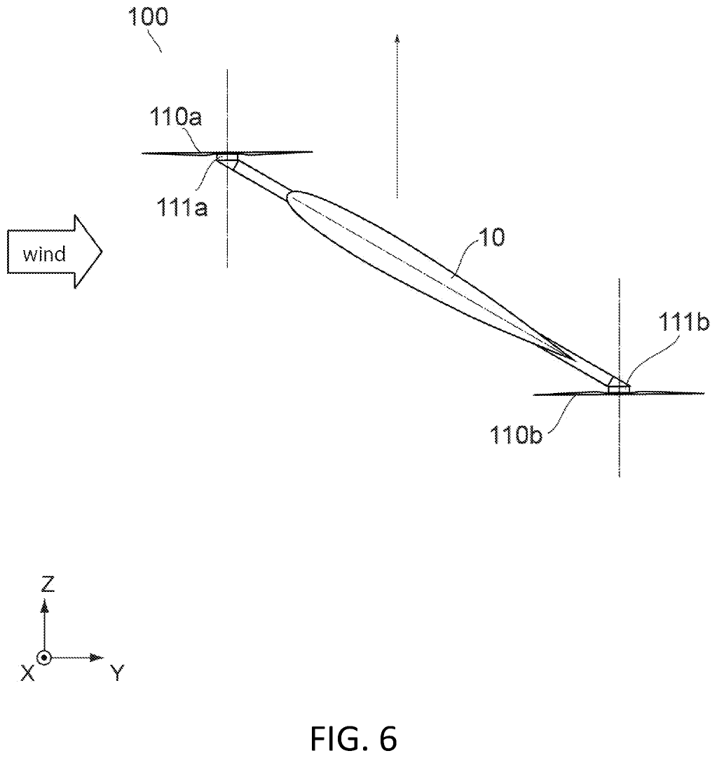

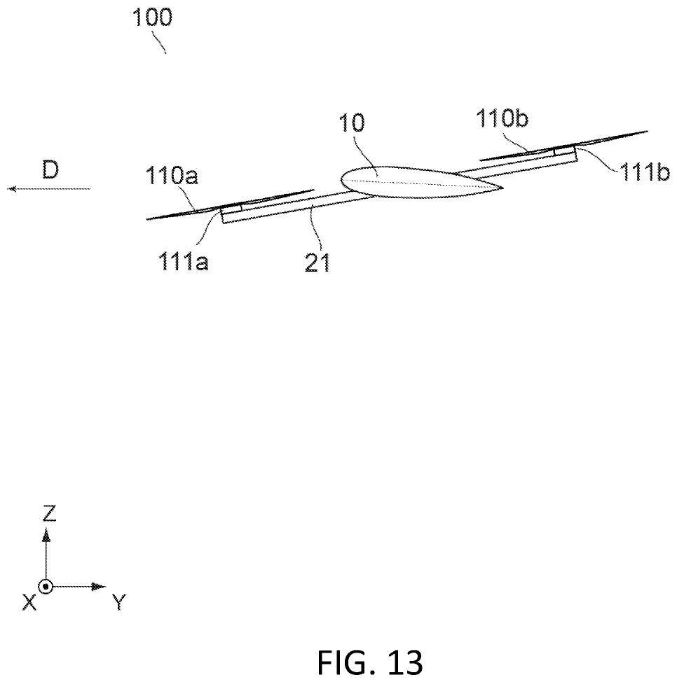

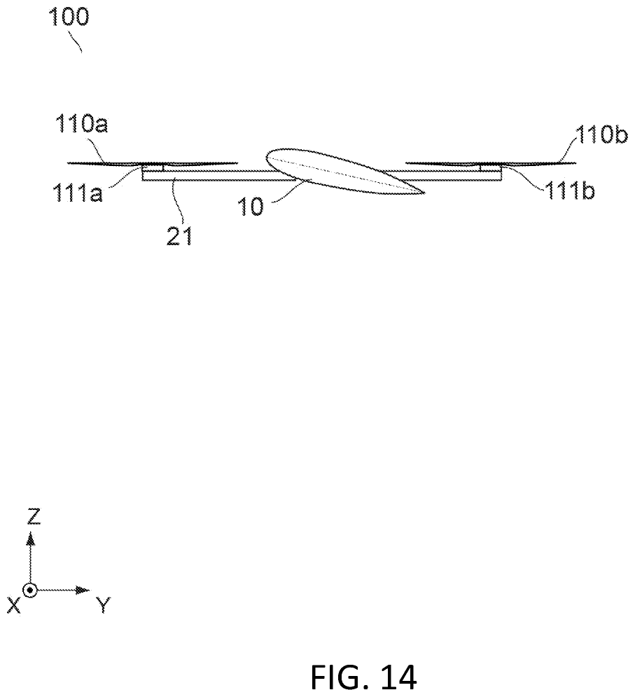

An example of a low-drag shape is the symmetrical airfoil shape shown in FIG. 13-14. This shape is known to have a lift coefficient of zero at an angle of attack of zero. Therefore, for example, when a flight vehicle equipped with a main body part 10 or wing part 11 that is comprised of the main body part 10 or wing part 11 that does not generate lift during cruise, hovering, or vertical ascent in an environment with winds below cruise speed, the main body part 10 or the wing part 11 will have a positive angle of attack and generate positive lift, as illustrated in FIG. 6.

Suppose a positive lift force is exerted on the flight vehicle 100 performing the descent. In that case, the descent will be inhibited, increasing the time required for landing and a situation where landing may not be possible. By changing the nose direction to downwind, the attitude of the main body part 10 or wing part 11 is likely to be at a negative angle of attack. Therefore, the flight vehicle will no longer have a positive lift or will have a negative lift, which is expected to reduce the increase in the time required for landing and increase the effective speed.

If the wind is in the third wind speed range beyond the second wind speed range, the nose direction control method may be changed, and the routine may be entered for high wind conditions.

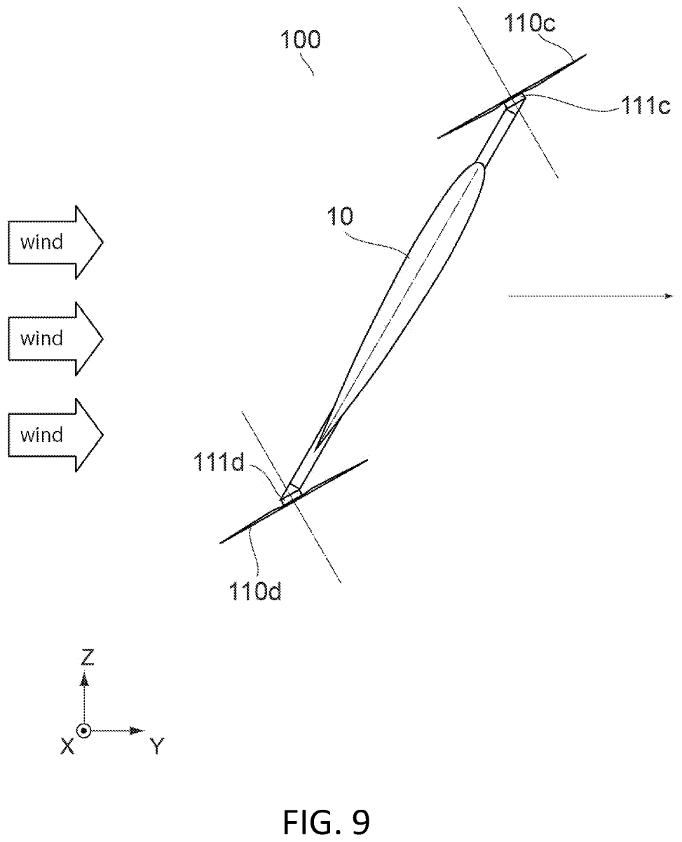

As a more specific example, as illustrated in FIG. 9, for wind speeds above the threshold of the second wind speed range (i.e., wind speeds in the third wind speed range), if the nose of the flight vehicle is downwind and the tail is facing upwind, the attitude of the main body part 10 or wing part 11 will have an even stronger negative angle of attack. In this case, the projected area to the wind increases significantly, and the drag force increases accordingly. When the flight vehicle 100 is swept downwind by the wind, the flight vehicle 100 increases the output of the nose-side rotor blades to resist the wind even more strongly, and the negative angle of attack becomes even stronger, resulting in a vicious cycle of increased drag. As a result, landing at the destination may become difficult.

In addition, the rotor blade spacing in the Y direction in the top view becomes narrower, making it easier to lose balance than when the rotor blade spacing is wider.

The behavior of flight vehicle 100 when the wind is in the third wind speed range beyond the second wind speed range may vary depending on the configuration and characteristics of flight vehicle 100 as described above. In addition, since the direction in which the flight vehicle 100 is allowed to move varies depending on the environment around the destination, the following various behaviors can be assumed for the high winds routines to comprise.

For example, in conducting a flight for survey purposes, if landing at another landing site other than the planned landing site is permissible, there is a way to change the designed landing site and attempt to land at a different location.

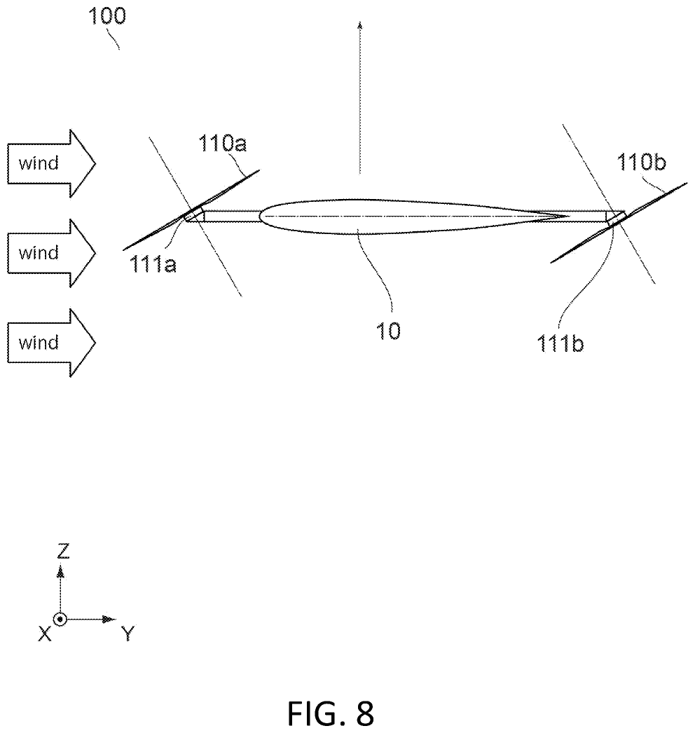

Instead of facing the nose and tail of the flight vehicle 100 directly to upwind, the side or oblique direction of the flight vehicle 100 may be directed to upwind to prevent the generation of lift and increase of drag. Based on the schematic illustrated in FIG. 15, for a wind blowing from direction 0 (12), the nose should be directed in directions 1-5, 7-11, and so on. This makes it possible to achieve an intermediate state between the state shown in FIG. 8 (with the nose facing the wind direction) and the state shown in FIG. 9 (with the tail facing the wind direction). As a result, in the third wind speed range, the nose may be oriented in direction 4, 5, 7, 8, etc., giving priority to the generation of lift over the increase in drag, or in direction 1, 2, 10, 11, etc., giving priority to the increase in drag (see especially the next paragraph) over the generation of lift.

Another example is shown in FIG. 8, where the nose is upwind (e.g., directly opposite) and the tail is downwind, concerning the wind speed within the third wind speed range. In this case, the increase in the projected area against the wind (i.e., the area visible from the front side when the windward side is defined as the front side) when the rotating surface of the rotor blade is tilted by the same amount is smaller than when the nose is set to the leeward side. The tail is set to the windward side (e.g., facing forward). Thus, the increase in drag is reduced, and the flight vehicle 100 is less likely to be swept in the downwind direction. As mentioned above, positive lift is generated by setting the nose to the upwind side, making landing difficult. However, avoiding the aircraft from being swept in the XY direction and coming into contact with surrounding structures can be avoided.

### Details of the Second Embodiment

In the details of the second embodiment of this invention, the components that overlap with those of the first embodiment operate in the same manner, so they will not be described again.

When a flight vehicle 100, which does not have a threshold value for the wind speed range regarding the determination of the landing maneuver, performs a landing maneuver, it is difficult to adjust the direction of approach, etc., in advance to perform the descent. In such cases, the flight vehicle rotates in the yaw direction on the spot after reaching the destination. Furthermore, based on state information such as motor speed, flight vehicle position, and sensor information (e.g., vibration sensor, gyro sensor, acceleration sensor, etc.), the acquired state information is compared with reference state information for which reference values are set. Based on the results, landing performance can be improved by descending at a point where the lift and drag forces are in good balance (e.g., at a point where the lift and drag forces are lower than the said reference value or where the change in the state information within a predetermined time is small).

An example of the operation is described based on the schematic illustrated in FIG. 15. Suppose the wind is blowing from direction 0 (12), and the flight vehicle's nose direction is facing direction 2. If the flight vehicle starts to rotate in the yaw direction (e.g., clockwise) on the spot, as the nose direction changes from direction 3 to direction 4, the flight vehicle may tend to lose altitude or lean less, even if the motor speed is the same. In such a case, it is understood that it is preferable for the flight vehicle to enter the landing operation with its nose pointing in direction 4 rather than direction 3. If, after further rotation, it is confirmed that the easiest direction for descent is direction 6, and that it is again difficult to lose altitude after direction 7, then the flight vehicle should descend with direction 6 as the nose direction.

According to this landing method, it is not necessary to calculate in advance the influence values due to the characteristics of the airframe or the surrounding environment. Therefore, it is possible to obtain the state of lift and drag forces applied to the flight vehicle from information obtained from various sensors (e.g., gyro sensor, altitude sensor, GPS receiver, etc.) installed in the flight vehicle, and to obtain a suitable upward nose direction for the landing operation.

The flight vehicle with directionality can be expected to be used as a rotary wing aircraft for industrial applications in delivery, surveillance, research, and other operations. The rotary wing aircraft of the invention can also be used in aircraft-related industries such as multicopter drones, etc. Furthermore, the invention can be used in various industries such as the security field, agriculture, research, disaster response, infrastructure inspection, etc.

The above mentioned embodiments are merely examples to facilitate understanding of the invention and are not intended to be construed as limitations to the invention. It goes without saying that the invention may be changed and improved without departing from its purpose, and that the invention includes its equivalents.

### DESCRIPTION OF REFERENCE NUMERALS

10 Main body part
11 Wing part
20 Flight part
30 Cargo/load
31 Rotating part
100 Flight vehicle
110a-110e Propeller
111a-111e Motor

1. A method of landing a flight vehicle,
wherein the flight vehicle generates lift in response to wind from the nose direction of its airframe, comprising:
controlling the nose direction of the airframe based on wind speed data and wind direction data related to the landing site, and initiating the descent of the airframe.

2. The method of landing a flight vehicle according to claim 1,
wherein the lift force is generated by the shape of the body of the airframe.

3. The landing method for a flight vehicle according to claim 1,
wherein the lift force is generated by the wing parts of the airframe.

4. The method of landing a flight vehicle according to claim 1,
wherein the controlling of the nose direction of the airframe is a yaw rotation on-the-spot.

5. The method of landing a flight vehicle according to claim 1,
wherein the control of the nose direction of the airframe is a turn.

6. The method of landing a flight vehicle according to claim 1,
wherein the controlling of the nose direction of the airframe is upwind of the nose direction of the airframe when the wind speed indicated by the wind speed data is in the first wind speed range where no lift is generated.

7. The method of landing a flight vehicle according to claim 1,
wherein the controlling of the nose direction of the airframe is to set the nose direction of the airframe to the downwind side when the wind speed indicated by the wind speed data is in the second wind speed range that generates the lift force.

8. The method of landing a flight vehicle according to claim 7,
wherein the controlling of the nose direction of the airframe is to set the nose direction of the airframe to the windward side when the wind speed is in the third wind speed range, which is even stronger than the second wind speed range.

9. The method of landing a flight vehicle according to claim 7,
wherein the control of the nose direction of the airframe is to change the planned landing site if the wind speed is in the third wind speed range, which is even stronger than the second wind speed range.

10. A flight vehicle,
wherein the flight vehicle generates lift in response to wind from the nose direction of the airframe,
wherein the nose direction of the airframe is controlled based on wind speed data and wind direction data related to the landing site to initiate the descent of the airframe.

11. An information processing apparatus for executing a landing method for a flight vehicle,
wherein the flight vehicle generates lift in response to wind from the nose direction of the airframe,
wherein the method of landing the flight vehicle is controlling the nose direction of the airframe based on wind speed data and wind direction data related to the landing site, and initiating the descent of the airframe.

12. (canceled)

13. The method of landing a flight vehicle according to claim 2,
wherein the controlling of the nose direction of the airframe is a yaw rotation on-the-spot.

14. The method of landing a flight vehicle according to claim 3,
wherein the controlling of the nose direction of the airframe is a yaw rotation on-the-spot.

15. The method of landing a flight vehicle according to claim 2,
wherein the control of the nose direction of the airframe is a turn.

16. The method of landing a flight vehicle according to claim 3,
wherein the control of the nose direction of the airframe is a turn.
